(19) United States
(12) Patent Application Publication
(10) Pub. No.: US 2017/0290032 A1
(43) Pub. Date: Oct. 5, 2017

(54) IMPROVED APPARATUS AND METHOD FOR TRACKING SHORT MESSAGES OF TALK GROUP MEMBERS

(71) Applicant: MOTOROLA SOLUTIONS, INC., CHICAGO, IL (US)

(72) Inventors: KANG-KAI ZHAO, CHENGDU (CN); DA-JUN CHEN, CHENGDU (CN); YONG LI, CHENGDU (CN); YONG TIAN, CHENGDU (CN); WU YANG, CHENGDU (CN)

(21) Appl. No.: 15/507,269

(22) PCT Filed: Nov. 13, 2014
(86) PCT No.: PCT/CN2014/090966

§ 371 Date: Feb. 28, 2017

(51) Int. Cl. H04W 72/12; H04W 4/02; H04W 4/10

(52) U.S. Cl. CPC H04W 72/121; H04W 4/10; H04W 4/02

(57) ABSTRACT

A subscriber device joins a talk group and receives, via a control channel, parameters defining a plurality of assigned downlink data transmission periods associated with the talk group on a downlink short data channel. The subscriber device determines from the parameters when a next downlink short data transmission for devices in the talk group will be transmitted on the downlink short data channel. The subscriber device switches to the downlink short data channel during the next transmission period.

### BACKGROUND OF THE INVENTION

A trunked communication system, such as a Land Mobile Radio (LMR) system, is one in which mobile or portable user terminals, such as mobile telephones, portable or mobile radios (herein collectively referred to as “radios”) can communicate via a network infrastructure. The network infrastructure generally includes fixed installations, for example, one or more fixed base stations and/or various sub-systems that manage and control the system. The radios operating in trunked communication systems share radio frequency (RF) communication channels (also referred to as traffic/data channels) and are configured to send and receive calls and other data on shared traffic channels. A site controller, for example a base station, manages transmissions sent from radios on free traffic channels whose availability is determined by the site controller. The site controller assigns one or more channels as the “control channel”, wherein on the control channel the site controller transmits, to the radios, system information and other data associated with the shared traffic channels.

Each radio may be configured to communicate with a group of radios (referred to herein as a talk group). For example, a radio used by a firefighter may be affiliated with a firefighter talk group and a radio used by a police officer may be affiliated with a police talk group. In some circumstances, members of a talk group may transmit location data, sensor information or other short data to other talk group members. For example, in a fire emergency scene, firefighters may want to transmit location data so that each firefighter in the firefighter talk group is aware of the locations of other firefighters in the firefighter talk group at the emergency scene. In another example, police officers in a police talk group may also want to transmit location data to other talk group members to, for example, respond faster to back-up calls. In some current implementations, each talk group is periodically assigned a downlink data channel that is used to transmit location data to talk group members. When the communication system includes a large number of talk groups, a significant number of the downlink data channels that could otherwise be used to transmit calls between radios are used to transmit location data to talk group members.

Accordingly, there is a need for an improved method and apparatus for tracking short messages of talk group members.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communications system used in accordance with some embodiments.

FIG. 2 is a block diagram of a location control message used in accordance with some embodiments.

FIG. 3 is another block diagram of a location control message used in accordance with some embodiments.

FIG. 4 is a timing diagram of a short data channel in accordance with some embodiments.

FIG. 5 is a block diagram of a communication device used in accordance with some embodiments.

FIG. 6 is a flow diagram of a method used by a radio in accordance with some embodiments.

FIG. 7 is a block diagram of a controller used in accordance with some embodiments.

FIG. 8 is a flow diagram of a method used by a controller in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments are directed to methods and apparatuses for tracking short messages of talk group members. A subscriber device joins a talk group and receives, via a control channel, parameters defining a plurality of assigned downlink data transmission periods associated with the talk group on a downlink short data channel. The subscriber device determines from the parameters when a next downlink short data transmission for devices in the talk group will be transmitted on the downlink short data channel. The subscriber device switches to the downlink short data channel during the next transmission period.

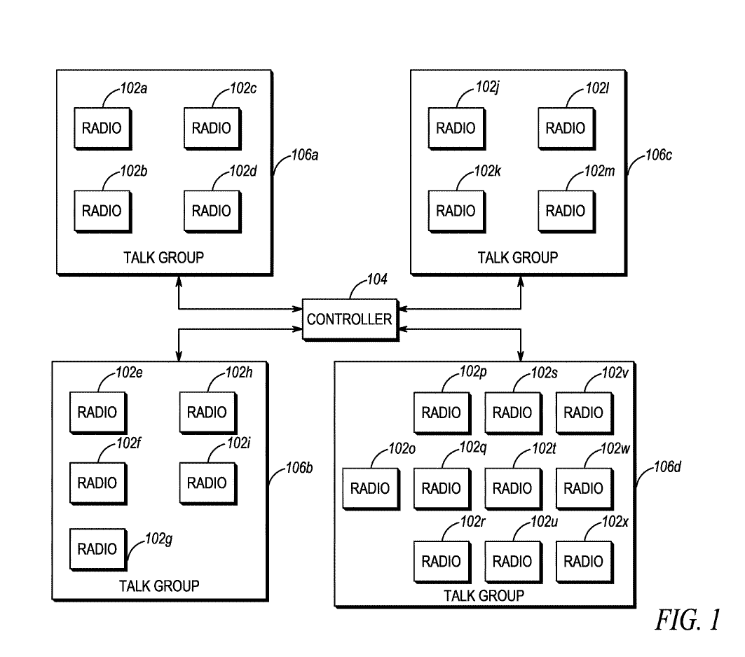

FIG. 1 is a block diagram of a communications system used in accordance with some embodiments. Communications system 100 includes communication devices (also referred to as subscriber devices 102 or radios 102 (i.e., radios 102a-102x)). Radios 102 may be, for example portable two-way radios, mobile radios, or other similar radios. Communications system 100 also includes a controller 104 (also referred to herein as a radio controller 104 or a controller device 104), which is configured to manage downlink short data transmissions to radios 102 on a dedicated short data channel, i.e., a shared and dedicated downlink data channel used to transmit location information, sensor information or any short data to be shared across talk group members. Radios 102 and controller 104 may be configured to operate on the same radio frequency channel and they may operate according to, for example, the Association of Public Safety Communications Officials International (APCO) Project 25 (P25) standard, the Terrestrial Trunked Radio (TETRA) protocol, or similar radio protocol.

At or subsequent to registering with system 100, each of radios 102 may join one or more talk groups. For example, radios 102a-102d may join a first talk group 106a, radios 102e-102i may join a second talk group 106b, radios 102j-102m may join a third talk group 106c; and radios 102o-102x may join a fourth talk group 106d. Radios 102 may transmit, for example, on a periodic basis or during a specified period, short data including, for example, location data, telemetry data and/or biometrics data to controller 104. For example, each radio may obtain its current location from a global positioning satellite (GPS) and/or via a triangulation process and transmit the obtained location data to controller 104 on a periodic basis or during a specified period.

Subsequent to receiving short data transmitted from radios 102a-102o, controller 104 may aggregate the received short data by talk group 106. For instance, controller may aggregate the short data received from radios 102a-102d in first talk group 106a, controller may aggregate the short data received from radios 102e-102i in second talk group 106b, controller may aggregate the short data received from radios 102j-102m in third talk group 106c, and controller may aggregate the short data received from radios 102o-102x in fourth talk group 106d. Controller 104 is thereafter configured to transmit the aggregated short data to radios 102 during transmission periods assigned to each talk group 106. For instance, controller 104 may send the location data associated with radios 102a-102d during a transmission period assigned to first talk group 106a on the short data channel; controller 104 may send the location data associated with radios 102e-102i during a transmission period assigned to second talk group 106b on the short data channel; controller 104 may send the location data associated with radios 102j-102m during a transmission period assigned to third talk group 106c on the short data channel; and controller 104 may send the location data associated with radios 102o-102x during a transmission period assigned to fourth talk group 106d on the short data channel. Controller 104 may transmit the location data for each talk group in a transmission period assigned to the talk group on the shared and dedicated downlink short data channel according to, for example, a Time Division Multiple Access (TDMA) access scheme. Each time slot/transmission period may have a fixed span of, for example, 200 ms.

At or subsequent to registering with system 100, each radio 102 is provided information about a transmission period (for example, time slot information) on the short data channel for its associated talk group(s). Each radio 102 may also receive a mapping table that maps each talk group to a specific transmission period on the short data channel. The mapping table may be modified based on changes to the number of talk groups, based on additions of new talk groups, based on removal of existing talk groups, based on additions of radios to existing talk group(s), or for some other reason. In an embodiment, controller 104 may transmit a talk group Trunked Signaling Block (TSBK) message (also referred to herein as a location control message or a control message) on a control channel to update information in the mapping table. The location control message may include parameters defining a plurality of assigned downlink data transmission periods associated with talk groups on the short data channel.

Controller 104 uses the aggregated location data, among other information, to configure the parameters of the location control message. Based on the parameters transmitted in the location control message, each radio 102 is configured to determine a specific downlink data transmission period when controller 104 is to transmit location data for each talk group. Therefore, the location control message may, for example, provide time slot synchronization information so that each radio 102 may switch to the short data channel during a transmission period when controller 104 is configured to send short data for the talk group to which the radio belongs.

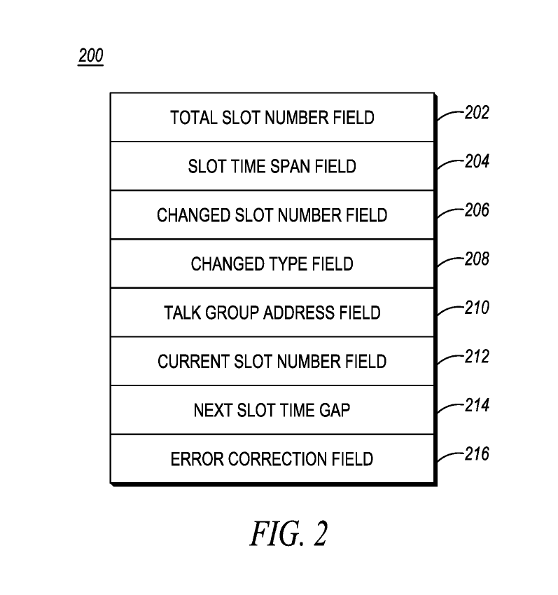

FIG. 2 is a block diagram of a location control message 200 used in accordance with some embodiments. Location control message 200 may include, among other information, a total slot number field 202, a slot time span field 204, a changed slot number field 206, a changed type field 208, a group address field 210, a current slot number field 212, a next slot time gap 214, and an error correction field 216. Total slot number field 202 indicates the number of talk group-associated slots in each dynamically sized repeating block of time slots assigned to the short data channel. Slot time span field 204 indicates the time span of each time slot. When a time slot has been changed, changed slot number field 206 indicates the time slot that has been changed. If no time slot is changed, changed slot number field 206 may be left blank or set to zero or NULL. When a time slot has been changed, changed type field 208 indicates the kind of change for the slot specified in the changed slot number field 206. For instance, changed type field may indicate that a time slot has been changed, assigned, added and/or removed. Talk group address field 210 indicates the talk group address associated with the changed time slot identified in the changed slot number field 206. Current slot number field 212 indicates the time slot number currently being transmitted on the short data channel. Next slot time gap field 214 indicates the time gap between the current time slot being transmitted on the short data channel and the next time slot on the short data channel. Radios 102 may use the information in the current slot number field 212 and next slot time gap field 214 to synchronize one or more timers in the radios with the short data channel, so that a separate synchronization process does not need to be executed after switching to the short data channel before receiving talk group associated short data.

Location control message 200 may be broadcast periodically or intermittently on the control channel. Location control message 200 may also be broadcasted when there is a change in the mapping table that maps each talk group to a specific transmission period on the short data channel. Subsequent to receiving location control message 200, each radio 102 uses information in location control message 200 to determine the total number of time slots on the short data channel and the span of each time slot. Using the information in total slot number field 202 and slot time span field 204, each radio 102 may calculate the time period including all time slots on the short data channel (i.e., the total number of transmission periods on the short data channel). Considering that subsequent to registering with system 100 each radio 102 is provided the time slot(s) for its associated talk group(s), when each radio 102 receives location control message 200, the radio may use the information in location control message 200 to determine when its next talk group location information is to be transmitted on the short data channel (i.e., the radio may use the information location control message 200 to determine the upcoming transmission period for its talk group).

Using the example above where there are four talk groups 106, controller 104 may broadcast the aggregated location information for radios in each talk group 106 in four corresponding time slots in each repeating block of time slots on the short data channel. For example, controller 104 may send the aggregated location information for the first talk group 106a (i.e., the talk group including radios 102a-102d) in time slot 1 of a repeating block of time slots; controller 104 may send the aggregated location information for the second talk group 106b (i.e., the talk group including radios 102e-102i) in time slot 2 of the repeating block of time slots; controller 104 may send the aggregated location information for the third talk group 106c (i.e., the talk group including radios 102j-102m) in time slot 3 of the repeating block of time slots; and controller 104 may send the aggregated location information for the fourth talk group 106d (i.e., the talk group including radios 102o-102x) in time slot 4 of the repeating block of time slots.

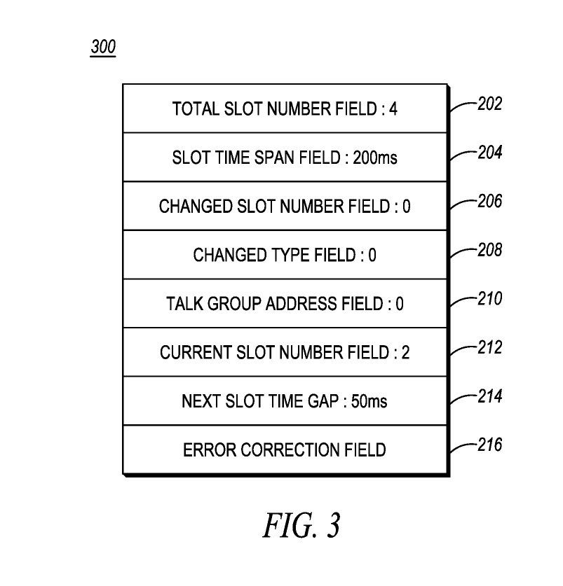

FIG. 3 is another block diagram of a location control message 300 used in accordance with some embodiments. In location control message 300, total slot number field 202 indicates that there are four time slots in a dynamically sized repeating block of time slots on the short data channel; slot time span field 204 indicates that the time span of each time slot is 200 ms; current slot number field 212 indicates that time slot number 2 is currently being transmitted on the short data channel; next slot time gap field 214 indicates the time gap between current time slot and the next time slot is 50 ms. In location control message 300, changed slot number field 206, changed slot number field 206 and group address field 210 may be left blank or set to zeros or NULL to indicate no time slot is being changed. In embodiments in which a particular time slot is added and assigned to a talkgroup, changed slot number field 206 may indicate, for example, 4 for a newly added fourth time slot and group address field 210 may indicate, for example, a group address associated with talk group four assigned to radios 102o-102x.

In an embodiment, each radio 102 may use the following formula to calculate a beginning of an upcoming transmission period on the short data channel when the aggregated location information for its talk group members is to be transmitted:

a beginning of an upcoming transmission period=(a target time slot−a current time slot−1)*a slot time span+a next time slot gap,
wherein the target time slot is an upcoming time slot on the short data channel when aggregated location information for a talk group is to be transmitted on the short data channel, the current time slot is a time slot that is currently being used to transmit data on the short data channel, the slot time span is the time span of each time slot on the short data channel, and the next time slot gap is a time gap between the current time slot and the next time slot on the short data channel.

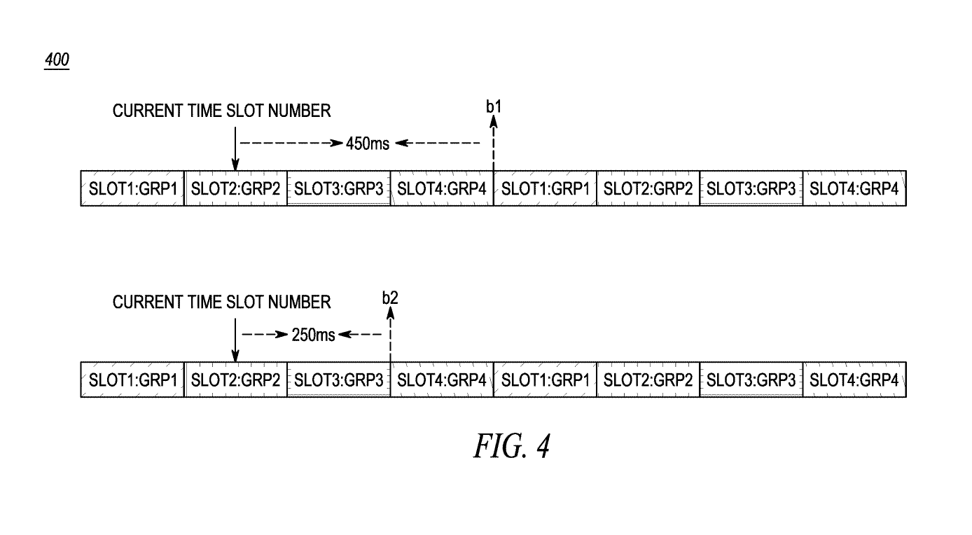

FIG. 4 is a timing diagram 400 of a short data channel with 4 time slots in accordance with some embodiments. Using the beginning of an upcoming transmission period formula and the information in location control message 300, in one example and as shown in FIG. 4, radio 102a may calculate the beginning of its next/upcoming time slot (shown as b1) on the short data channel as (5-2-1)*200 ms +50 ms=450 ms, i.e., radio 102a may calculate that the aggregated location information for its talk group members will be transmitted 450 ms later than the current transmission on the short data channel. Radio 102o may calculate its next/upcoming time slot (shown as b2) on the short data channel as (4-2-1)*200 ms +50 ms=250 ms, i.e., radio 102o may calculate that the aggregated location information for its talk group members will be transmitted 250 ms later than the current transmission on the short data channel. Subsequent to calculating its next time slot, radio 102a may start a 450 ms timer and radio 102o may start a 250 ms timer, wherein after each respective timer set by radios 102a and 102o expires, the radio switches its transceiver to the short data channel to receive the short data message.

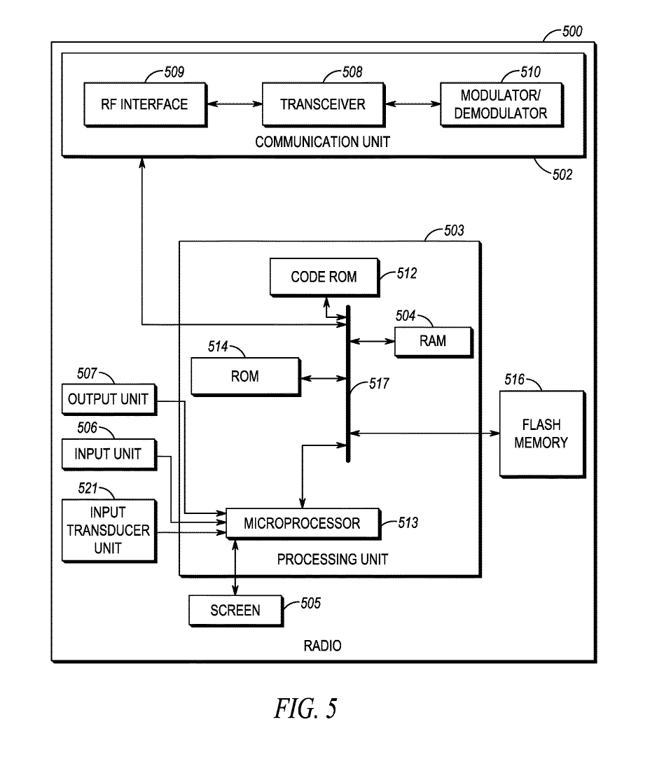

FIG. 5 is a block diagram of a radio 500, such as radio 102 of FIG. 1, used in accordance with some embodiments. Radio 500, for example, may include a communications unit 502 coupled to a common data and address bus 517 of a processor 503. Radio 500 may also include an input unit (e.g., keypad, pointing device, etc.) 506, an output transducer unit (e.g., speaker) 507, an input transducer unit (e.g., a microphone) (MIC) 521, and a display screen 505, each coupled to be in communication with the processor 503.

The processor 503 may include a code read-only memory (ROM) 512 for storing data for initializing system components of radio 500. The processor 503 may further include a microprocessor 513 coupled, by the common data and address bus 517, to one or more memory devices, such as a read only memory (ROM) 514, a random access memory (RAM) 504, and/or a static memory 516. One or more of ROM 514, RAM 504 and flash memory 516 may be included as part of processor 503 or may be separate from, and coupled to, the processor 503.

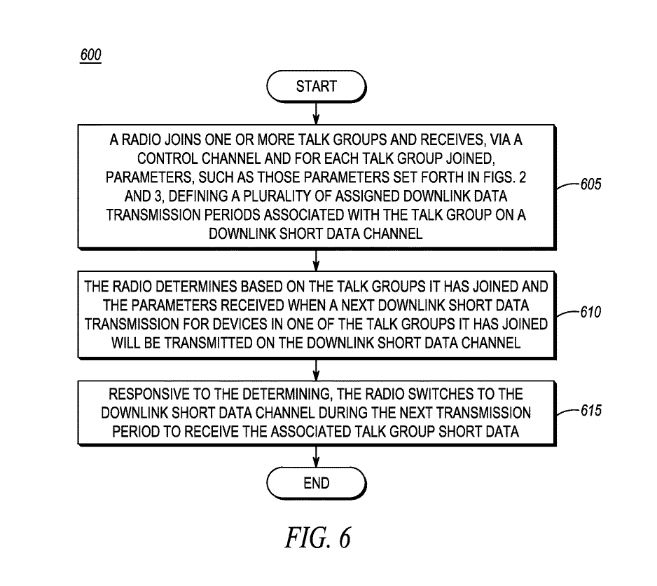

Communications unit 502 may include an RF interface 509 configurable to communicate with network components and other user equipment within its communication range. Communications unit 502 may include one or more broadband and/or narrowband transceivers 508, such as an Long Term Evolution (LTE) transceiver, a Third Generation (3G) (3GGP or 3GGP2) transceiver, an Association of Public Safety Communication Officials (APCO) Project 25 (P25) transceiver, a Digital Mobile Radio (DMR) transceiver, a Terrestrial Trunked Radio (TETRA) transceiver, a WiMAX transceiver perhaps operating in accordance with an IEEE 802.16 standard, and/or other similar type of wireless transceiver configurable to communicate via a wireless network for infrastructure communications. Communications unit 502 may also include one or more local area network or personal area network transceivers such as Wi-Fi transceiver perhaps operating in accordance with an IEEE 802.11 standard (e.g., 802.11a, 802.11b, 802.11g), or a Bluetooth transceiver. The transceivers may be coupled to a combined modulator/demodulator 510. The one or more memory devices 512, 514 and 516 are configured to store non-transitory computer-executable instructions to perform a set of functions such as one or more of the steps set forth in FIG. 6.

FIG. 6 is a flow diagram of a method 600 implemented in accordance with some embodiments. At 605, a radio joins one or more talk groups and receives, via a control channel and for each talk group joined, parameters, such as those parameters set forth in FIGS. 2 and 3 above, defining a plurality of assigned downlink data transmission periods associated with the talk group on a downlink short data channel. At 610, the radio determines based on the talk groups it has joined and the parameters received when a next downlink short data transmission for devices in one of the talk groups it has joined will be transmitted on the downlink short data channel. At 615, responsive to the determining, the radio switches to the downlink short data channel during the next transmission period to receive the associated talk group short data.

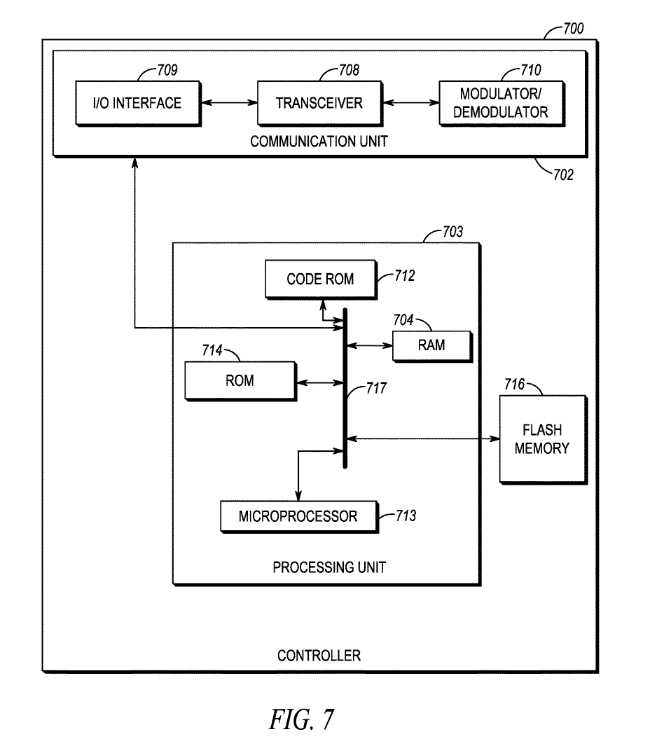

FIG. 7 is a block diagram of a controller 700, such as controller 104 of FIG. 1, used in accordance with some embodiments. Controller 700, for example, may include a communications unit 702 coupled to a common data and address bus 717 of a processor 703. The processor 703 may include a code read-only memory (ROM) 712 for storing data for initializing system components of controller 700. The processor 703 may further include a microprocessor 713 coupled, by the common data and address bus 717, to one or more memory devices, such as a read only memory (ROM) 714, a random access memory (RAM) 704, and/or a static memory 716. One or more of ROM 714, RAM 704 and flash memory 716 may be included as part of processor 703 or may be separate from, and coupled to, the processor 703.

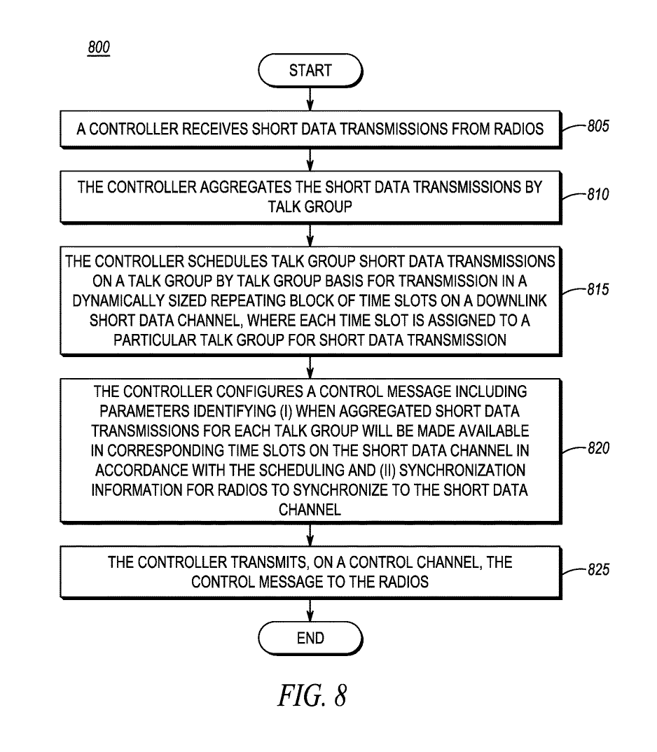

Communications unit 702 may include a wired or wireless input/output I/O interface 709 configurable to communicate with network components and other user equipment. Communications unit 702 may include one or more broadband and/or narrowband transceivers 708, such as an Long Term Evolution (LTE) transceiver, a Third Generation (3G) (3GGP or 3GGP2) transceiver, an Association of Public Safety Communication Officials (APCO) Project 25 (P25) transceiver, a Digital Mobile Radio (DMR) transceiver, a Terrestrial Trunked Radio (TETRA) transceiver, a WiMAX transceiver perhaps operating in accordance with an IEEE 802.16 standard, and/or other similar type of wireless transceiver configurable to communicate via a wireless network for infrastructure communications. Communications unit 702 may also include one or more local area network or personal area network transceivers such as Wi-Fi transceiver perhaps operating in accordance with an IEEE 802.11 standard (e.g., 802.11a, 802.11b, 802.11g), or a Bluetooth transceiver. Still further, the communication unit 702 may additionally or alternatively include one or more wireline transceivers 708, such as an Ethernet transceiver, a Universal Serial Bus (USB) transceiver, or similar transceiver configurable to communicate via a twisted pair wire, a coaxial cable, a fiber-optic link or a similar physical connection to a wireline network. The transceivers may be coupled to a combined modulator/demodulator 710. The one or more memory devices 712, 714 and 716 are configured to store non-transitory computer-executable instructions to perform a set of functions such as one or more of the steps set forth in FIG. 8.

FIG. 8 is a flow diagram of a method 800 implemented in accordance with some embodiments. At 805, a controller receives short data transmissions from radios. At 610, the controller aggregates the short data transmissions by talk group. At 615, the controller schedules talk group short data transmissions on a talk group by talk group basis for transmission in a dynamically sized repeating block of time slots on a downlink short data channel, where each time slot is assigned to a particular talk group for short data transmission. At 820, the controller configures a control message including parameters identifying (i) when aggregated short data transmissions for each talk group will be made available in corresponding time slots on the short data channel in accordance with the scheduling and (ii) synchronization information for radios to synchronize to the short data channel. At 825, the controller transmits, on a control channel, the control message to the radios.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
joining, by a subscriber device, a talk group and receiving, via a control channel, parameters defining a plurality of assigned downlink data transmission periods associated with the talk group on a downlink short data channel;
determining, by the subscriber device, from the parameters when a next downlink short data transmission for devices in the talk group will be transmitted on the downlink short data channel; and
responsive to the determining, switching, by the subscriber device, to the downlink short data channel during the next transmission period.

2. The method of claim 1, further comprising starting a timer responsive to the determining and switching to the downlink short data channel when the timer expires.

3. The method of claim 1, wherein the determining comprises determining a number of talk group-associated slots in each dynamically sized repeating block of time slots assigned to the short data channel and a span of each talk group-associated slot.

4. The method of claim 1, wherein the determining comprises determining an upcoming transmission period when location information for the talk group is to be transmitted on the downlink short data channel.

5. The method of claim 4, wherein the determining comprises calculating a beginning of the upcoming transmission period, wherein
the beginning of the upcoming transmission period=(a target time slot−a current time slot−1)*a slot time span+a next time slot gap,
wherein the target time slot is an upcoming time slot on the short data channel when aggregated location information for the talk group is to be transmitted on the short data channel, the current time slot is a time slot currently being used to transmit data on the short data channel, the slot time span is the time span of each time slot on the short data channel, and the next time slot gap is a time gap between the current time slot and the next time slot on the short data channel.

6. The method of claim 1, wherein the receiving comprises receiving the parameters when there is a change to a mapping table that maps the talk group to a specific transmission period on the downlink short data channel.

7. The method of claim 1, wherein the parameters includes at least one of:
a total slot number field for indicating a number of talk group-associated slots in each dynamically sized repeating block of time slots assigned to the short data channel;
a slot time span field for indicating a time span of each time slot on the downlink short data channel;
a changed slot number field for indicating which time slot on the downlink short data channel is changed;
a changed type field for indicating a kind of change for the time slot specified in the changed slot number field;
a talk group address field for indicating a group address associated with the changed time slot indicated by the changed slot number field;
a current slot number field for indicating a time slot number for a time slot that is currently being used to transmit data on the downlink short data channel; and
a next slot time gap field for indicating a time gap between the time slot that is currently being used to transmit data on the downlink short data channel and a next time slot on the short data channel.

8. The method of claim 7, wherein the changed type field indicates that the time slot specified in the changed slot number field is one of added, assigned and removed.

9. The method of claim 7, further comprising synchronizing, by the subscriber device, a timer on the subscriber device with the downlink short data channel using the parameters received via the control channel, including a value in the current slot number field and a value in the next slot time gap field.

10. The method of claim 7, wherein a time span of the transmission period when downlink short data for the talk group is being transmitted on the downlink short data channel is 200 ms.

11. A subscriber device, comprising:
a memory storing non-transitory computer-executable instructions;
a transceiver;
a processor configured to perform a set of functions in response to executing the instructions, the set of functions including:
joining a talk group and receiving, via a control channel, parameters defining a plurality of assigned downlink data transmission periods associated with the talk group on a downlink short data channel;
determining from the parameters when a next downlink short data transmission for devices in the talk group will be transmitted on the downlink short data channel; and
responsive to the determining, switching, by the subscriber device, to the downlink short data channel during the next transmission period.

12. The subscriber device of claim 11, further comprising a timer, wherein the set of functions further comprise starting the timer responsive to the determining and switching the transceiver to the downlink short data channel when the timer expires.

13. The subscriber device of claim 11, wherein the determining comprises determining a number of talk group-associated slots in each dynamically sized repeating block of time slots assigned to the short data channel and a span of each transmission period.

14. The subscriber device of claim 11, wherein the determining comprises determining an upcoming transmission period when location information for the talk group is to be transmitted on the downlink short data channel.

15. The subscriber device of claim 14, wherein the determining comprises calculating a beginning of the upcoming transmission period, wherein
the beginning of the upcoming transmission period=(a target time slot−a current time slot−1)*a slot time span+a next time slot gap,
wherein the target time slot is an upcoming time slot on the short data channel when aggregated location information for the talk group is to be transmitted on the short data channel, the current time slot is a time slot currently being used to transmit data on the short data channel, the slot time span is the time span of each time slot on the short data channel, and the next time slot gap is a time gap between the current time slot and the next time slot on the short data channel.

16. The subscriber device of claim 11, wherein the receiving comprises receiving the parameters when there is a change to a mapping table that maps the talk group to a specific transmission period on the downlink short data channel.

17. A radio controller comprising:
a memory storing non-transitory computer-executable instructions;
a transceiver; and
a processor configured to perform a set of functions in response to executing the instructions, the set of functions including:
receiving, via the transceiver, short data transmissions from radios;
aggregating the short data transmissions by talk group;
scheduling talk group short data transmissions on a talk group by talk group basis for transmission in a dynamically sized repeating block of time slots on a downlink short data channel, where each time slot is assigned to a particular talk group for short data transmission;
configuring a control message including parameters identifying (i) when aggregated short data transmissions for each talk group will be made available in corresponding time slots on the short data channel in accordance with the scheduling and (ii) synchronization information for radios to synchronize to the short data channel; and
transmitting, on a control channel, the control message to the radios.

18. The radio controller of claim 17, wherein the short data is location data for the radios in the talk group.

19. The radio controller claim 17, wherein the parameters include one or more of:
a total slot number field for indicating a number of talk group-associated slots in each dynamically sized repeating block of time slots assigned to the short data channel;
a slot time span field for indicating a time span of each time slot on the downlink short data channel;
a changed slot number field for indicating which time slot on the downlink short data channel is changed;
a changed type field for indicating a kind of change for the time slot specified in the changed slot number field;
a talk group address field for indicating a group address associated with the changed time slot indicated by the changed slot number field;
a current slot number field for indicating a time slot number for a time slot that is currently being used to transmit data on the downlink short data channel; and
a next slot time gap field for indicating a time gap between the time slot that is currently being used to transmit data on the downlink short data channel and a next time slot on the short data channel.

20. The radio controller of claim 19, wherein the changed type field indicates that the time slot specified in the changed slot number field is one of added and removed.
